(19) United States
(12) Patent Application Publication
(10) Pub. No.: US 2008/0288765 A1
(43) Pub. Date: Nov. 20, 2008

(54) Computer system capable of reducing booting time and method thereof

(75) Inventors: Chih-Li Huang, Taipei (TW); I-Wei Shen, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/798,802

(22) Filed: May 17, 2007

(51) Int. Cl. G06F 9/00

(52) U.S. Cl. 713/2

(57) ABSTRACT

The present invention discloses a method for reducing booting time of a computer system, and the method is applied in a computer booting process. If a computer receives an easy booting signal, the computer will read an easy booting data built in a basic input output system (BIOS) of the computer, start an operating system (OS) of the computer and enable at least one terminate-and-stay-resident (TSR) program of the operating system, such that the whole booting process can be completed quickly without wasting unnecessary time on self-testing all hardware devices for the booting process or loading all terminate-and-stay-resident programs.

### FIELD OF THE INVENTION

The invention relates to a method for reducing booting time of a computer system, more particularly to a method that a computer can be booting up quickly in accordance with an easy booting data built in a basic input output system (BIOS).

### BACKGROUND OF THE INVENTION

Although the feature of multi-function has allowed various types of electronic products to be used for more diverse purposes, it does not make the products with the feature more convenient. For example, in the computers sold on the market currently, all are capable of executing an operating system and applications, web browsing, playing computer games, as well as playing multimedia disks; as a result, even the most basic computers are equipped with a diversity of functions. But the multiplicity of functions also means that a computer system will need more time to load the variety of software and programs, or search for and check peripherals of the computer to see if they are functioning normally.

Generally, as shown in FIG. 1, the steps of computer booting comprise:
(101) enabling basic input/output system (BIOS);
(102) executing power-on self test (POST) to enable the hardware of the computer;
(103) after the POST is completed, the BIOS reads the first sector of the floppy disk in the computer (also called the booting sector);
(104) if the first sector of the floppy disk is absent, the BIOS reads the first sector of the hard disk in the computer (also called the master booting record, or MBR);
(105) loading a booting program from the first sector of the hard disk into the memory of the computer, and then loading it into the booting sector provided by the operating system stored in the hard disk; and
(106) entering the operating system and completing the booting of the computer.

In the above-mentioned booting process of computers, the step that takes up most of the time during booting is mainly the one in which the POST process is undertaken. This is due to the fact that there are too many peripherals coupled to computers. The peripherals include hard disks, floppy disk drives, CD-ROMs, Com Ports, LPT ports . . . and so on, which lengthens the booting time of computers. Another factor that also contributes to lengthy booting time is that there are excessive booting files, registry files, executable files, link files, or other terminate-and-stay-resident (TSR) programs to be loaded during booting time, which results in more time being needed for reading the files, and this is the consequence of installing too many applications or programs on the computer.

In response to this problem, some users have resorted to shut down or remove the TSR programs that are not often used from the operating system to shorten booting time. However, the general users usually lack the knowledge about how to shut down or remove the TSR programs, and they must also risk causing anomaly or breakdown of the computer if they have erroneously shut down or removed the TSR programs that are required by the computer. Moreover, some users have also tried to shorten booting time by installing hard disks of the SCSI interface (Small Computer System Interface), which fulfills the goal by elevating the reading speed of the hard disk in the computer. But the effect is limited and may not be cost-effective to use, which discourages many consumers from using such method.

### SUMMARY OF THE INVENTION

In light of the problem of lengthy booting time in computers of prior art, as well as disadvantages of previous methods used for shortening booting time, a computer system capable of reducing booting time and method thereof have been disclosed in the invention.

A major objective of the invention is to propose a method for reducing booting time that is applicable to the booting process of computers. When a computer receives an easy booting signal, the computer reads an easy booting data built in a basic input output system (BIOS) according to the easy booting signal, and then executes a power-on self test (POST) for the hardware of the computer specified in the easy booting data, subsequently starts an operating system, and enables at least one terminate-and-stay-resident (TSR) program of the operating system according to the easy booting data, thereby completing the whole booting process. As a result, the booting time of the computer can be significantly reduced.

Another objective of the invention is to propose a computer system capable of reducing booting time, which comprises a power supply unit, an easy booting switch, and a motherboard. The easy booting switch is disposed on a surface of the computer system and coupled to the power supply unit. The motherboard is electrically coupled to the power supply unit, and the motherboard comprises a CPU (central processing unit) and a ROM (read-only memory). The CPU is coupled to the ROM, and when the easy booting switch is pressed, the power supply unit provides voltage to the motherboard. When the CPU is enabled, it executes booting process in accordance with an easy booting data stored in the ROM, thereby completing the booting process quickly.

### BRIEF DESCRIPTION OF DRAWINGS

The technical means adopted by the present invention to achieve the above and other objectives can be best understood by referring to the following detailed description of the preferred embodiments and the accompanying drawings, wherein:

FIG. 1 is a flow chart of booting computers according to prior arts;

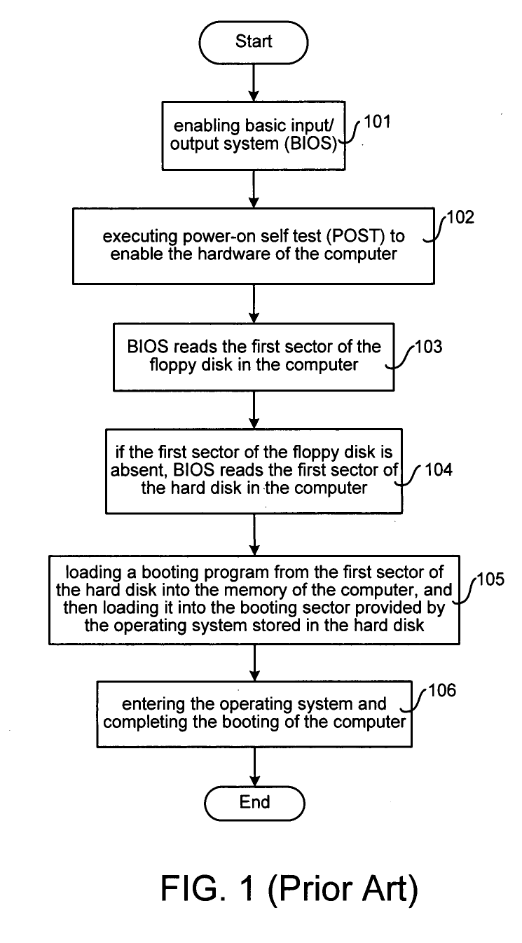

FIG. 2 is a schematic view of a computer system according to the invention;

FIG. 3 is a flow chart of booting computers according to the invention;

FIG. 4 is a flow chart showing the power-on self test process (POST) according to the invention.

### DETAILED DESCRIPTION OF PREFERRED EMBODIMENTS

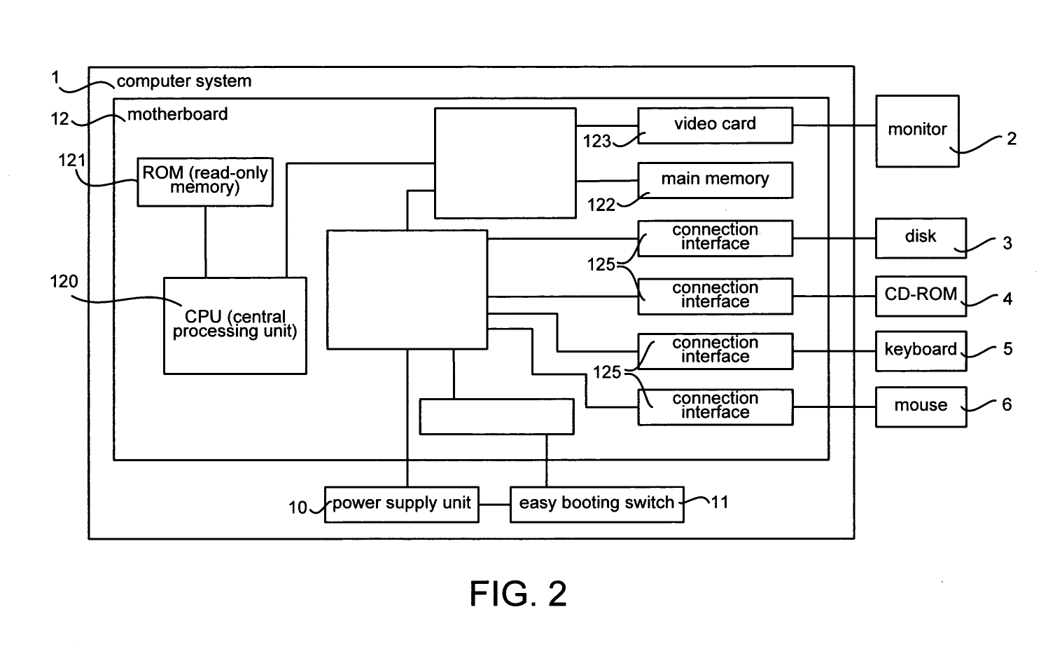

A computer system capable of reducing booting time has been disclosed in the invention. As indicated in FIG. 2, a computer system 1 comprises a power supply unit 10, an easy booting switch 11, and a motherboard 12. The easy booting switch 11 is disposed on a surface of the computer system 1, so as to allow users to press on it when it is necessary to execute an easy booting. The easy booting switch 11 is coupled to the power supply unit 10, and when the easy booting switch 11 is pressed, the power supply unit 10 provides voltage to the motherboard 12. The motherboard 12 comprises a central processing unit (CPU) 120 and a read-only memory (ROM) 121, and the CPU 120 is electrically coupled to the ROM 121, so that when the CPU 120 is enabled, it executes booting process in accordance with an easy booting data stored in the ROM 121.

In a preferred embodiment of the invention, as shown in FIG. 2, the ROM 121 has a normal booting data stored therein, when the CPU 120 is enabled, it executes booting process according to normal booting procedure of the normal booting data. Therefore, users are allowed to select between booting the computer according to normal booting procedure of the normal booting data, and speedy booting according to the easy booting data.

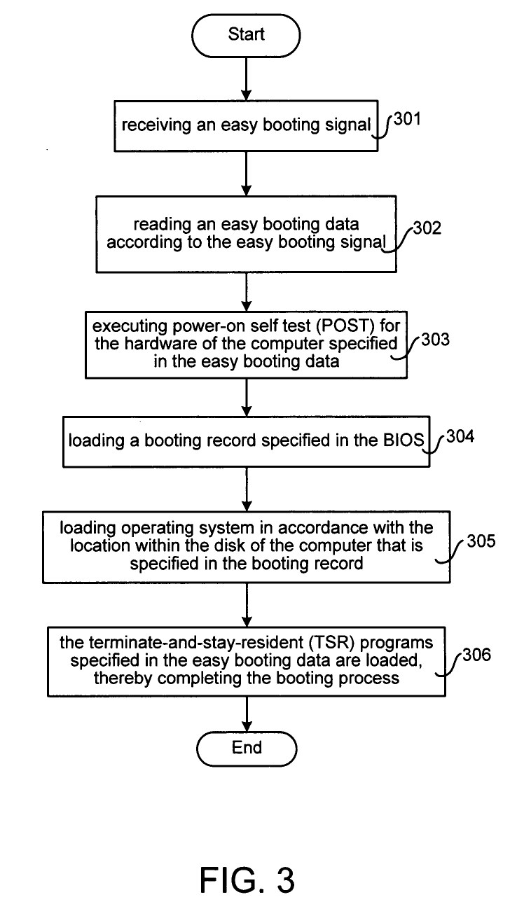

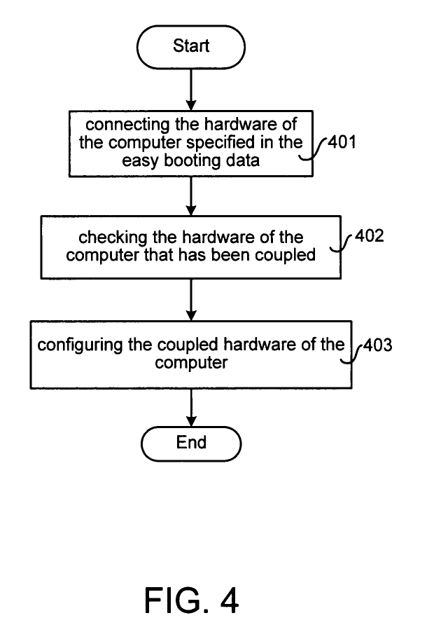

The invention also discloses a method for reducing booting time, as shown in FIG. 3, which is applied to a booting procedure of a computer, and a basic input/output system (BIOS) of the computer has an easy booting data built therein; comprising:
Step 301: Receiving an easy booting signal. In the invention, an easy booting switch 11 is disposed on a surface of the computer, when the easy booting switch 11 is pressed, the easy booting switch 11 generates and outputs an easy booting signal.
Step 302: Subsequently, reading an easy booting data according to the easy booting signal. The BIOS is further comprised of a normal booting data, and the normal booting data allows the computer to boot according to normal booting procedure.
Step 303: Executing power-on self test (POST) for the hardware of the computer specified in the easy booting data. In a preferred embodiment of the invention, as shown in FIG. 4, the step of executing power-on self test (POST) for the hardware of the computer specified in the easy booting data comprises the following steps:
   Step 401: Connecting the hardware of the computer specified in the easy booting data, and determining if the hardware of the computer specified in the easy booting data has coupled normally. For example, as indicated in FIG. 2, the coupled hardware can be components of the motherboard 12, a main memory 122, a video card 123, a connection interface 125, a disk 3, a keyboard 5, or a mouse 6, and so on.
   Step 402: Subsequently, checking the hardware of the computer that has been coupled, so as to ensure that the coupled hardware of the computer is functioning normally. In this invention, if the hardware is not coupled normally, or if the result of the checking indicated that the hardware is not functioning normally, a speaker disposed in the computer is used to give a sound to alarm the user about the aforesaid anomaly of the hardware, or a monitor 2 of the computer is used to display an error code or message that notifies the user about the aforesaid anomaly of the hardware.
   Step 403: Finally, configuring the coupled hardware of the computer. In this invention, the configuration of the coupled hardware of the computer is achieved by transmitting testing signals to chips or memories, and then setting or adjusting the configuration of the aforesaid chips or memories according to the returned signals thereof.
Step 304: Immediately following the step 303 is a step of loading a booting record specified in the BIOS. In the invention, when the computer reads the booting record specified in the BIOS, it searches for the disk 3 of the computer that can be used for booting, and then searches for and reads the booting record stored in the disk 3. Here an example is provided for the purpose of elucidation. After the hardware has completed the POST process, the BIOS determines whether it is possible to find any floppy disks in the computer, if there is no floppy disk for the BIOS to read, it subsequently searches for the presence of bootable hard disks in the computer. If any bootable hard disks are found, the booting record stored in the Master Booting Record (or MBR, which is the first sector at Cylinder 0, Head 0, and Sector 1 of the hard disk, or the sector that takes up the foremost 512 bytes in the hard disk) of the hard disk is read. In the preferred embodiment of the invention, the order for the BIOS in regard to searching the booting record is basing on the order set by the user in the BIOS, the aforesaid order (starting from the floppy disks, then moving on to hard disks) is provided as an example, and should not be used to limit the scope of the invention.
Step 305: Loading operating system in accordance with the location within the disk 3 of the computer that is specified in the booting record. When the computer reads the booting record, this allows the computer to read the program that is stored in the disk 3 and required for loading the operating system, in accordance with the location with the disk 3 that is specified in the booting record. For instance, the file allocation table (FAT), hidden system files that include io.sys, msdos.sys, as well as other relevant files like autoexec.bauser.dat, system.dat, win.ini, and system.ini, which are altogether required for loading the operating system.
Step 306: Finally, the terminate-and-stay-resident (TSR) programs specified in the easy booting data are loaded, thereby completing the booting process. The terminate-and-stay-resident (TSR) programs specified in the easy booting data can be programs like screen saver or antivirus software that are loaded at booting time. Consequently, it is no longer necessary to spend time on executing the POST process for all of the hardware, or loading all of the TSR programs during booting time, and thus the time needed for booting is significantly reduced.

In the preferred embodiment, after the computer has been successfully booted, users are allowed to activate all of the hardware and TSR programs of the computer in order to use all of the functions of the computer, by the mean of pressing a keyboard 5 of the computer. As soon as the computer receives a loading signal generated from the keyboard 5, it connects all of the hardware of the computer that has not been coupled, and performs checks and configuration thereof, followed by loading all of the TSR programs of the computer that have not been loaded. As a result, after the user has completed a speedy booting, if other functions or programs are needed, the user can connect or load the uncoupled hardware or the unloaded TSR programs by pressing the keyboard 5 to issue the loading signal.

The present invention has been described with a preferred embodiment thereof and it is understood that many changes and modifications to the described embodiment can be carried out without departing from the scope and the spirit of the invention that is intended to be limited only by the following claims.

What is claimed is:

1. A method for reducing booting time, which is applied to a computer, the method for reducing booting time comprising:
receiving an easy booting signal;
reading an easy booting data built in a basic input output system of the computer in accordance with the easy booting signal;
starting an operating system; and
enabling at least one terminate-and-stay-resident (TSR) program of the operating system in accordance with the easy booting data.

2. The method for reducing booting time of claim 1, wherein the easy booting signal is generated by pressing an easy booting switch disposed on a surface of the computer.

3. The method for reducing booting time of claim 1, wherein, after reading the easy booting data and before starting the operating system, the method further comprises a step of enabling a plurality of hardware of the computer in accordance with the easy booting data, and carrying out a power-on self test.

4. The method for reducing booting time of claim 3, wherein, when executing the power-on self test, the method further comprises:
connecting the hardware of the computer specified in the easy booting data;
checking the hardware of the computer that has been coupled; and
configuring the hardware of the computer that has been coupled.

5. The method for reducing booting time of claim 4, wherein, after carrying out the power-on self test and before starting the operating system, the method further comprises a step of reading a booting record specified in the basic input output system.

6. The method for reducing booting time of claim 5, wherein, when reading the booting record, the method further comprises the following steps:
searching disks of the computer that are used for booting; and
reading the booting record stored in the disks that have been found in the search.

7. The method for reducing booting time of claim 6, wherein, when searching for the booting record in the basic input output system, the method further comprises searching disks of the computer t according to the order specified in the basic input output system that is set by users.

8. The method for reducing booting time of claim 7, wherein, after starting the computer, the method further comprises:
receiving a loading signal generated by a keyboard of the computer;
connecting all of the hardware of the computer that has not been coupled, and performing checks and configuration thereof; and
loading all of the terminate-and-stay-resident programs of the computer that have not been loaded.

9. A computer system capable of reducing booting time, at least comprising:
a power supply unit;
an easy booting switch being disposed on a surface of the computer system and coupled to the power supply unit; and
a motherboard being electrically coupled to the power supply unit, and when the easy booting switch is pressed, the power supply unit provides voltage to the motherboard; the motherboard comprises a central processing unit and a read-only memory, the central processing unit is electrically coupled to the read-only memory, when the central processing unit is enabled, the central processing unit executes booting process in accordance with an easy booting data stored in the read-only memory.
